(19) United States
(12) Patent Application Publication
(10) Pub. No.: US 2007/0266545 A1
(43) Pub. Date: Nov. 22, 2007

(54) Impact wrench anvil and method of forming an impact wrench anvil

(76) Inventors: Thomas J. Bodine, Glenwood, MD (US); David S. Bruner, Bel Air, MD (US); Alan M. Paris, Baltimore, MD (US)

Correspondence Address: HARNESS, DICKEY & PIERCE, P.L.C., P.O. BOX 828, BLOOMFIELD HILLS, MI, 48303, US

(21) Appl. No.: 11/881,877

(22) Filed: Jul. 30, 2007

Related U.S. Application Data
(62) Division of application No. 11/031,726, filed on Jan. 7, 2005, now Pat. No. 7,249,638.

(51) Int. Cl. B23P 17/02

(52) U.S. Cl. 29/592

(57) ABSTRACT

An anvil adapted to be received within an impact wrench comprises a round body and a square head. The square head is formed at an end of the round body. A tapered ramp extends from the round body to the square head. A radius is formed in the tapered ramp.

### CROSS-REFERENCE TO RELATED APPLICATIONS

This application is a divisional application of U.S. pat. application Ser. No. 11/031,726 filed on Jan. 7, 2005. The disclosure of the above application is incorporated herein by reference.

### FIELD OF THE INVENTION

The present invention relates to an impact wrench and more particularly to an improved anvil in an impact wrench.

### BACKGROUND OF THE INVENTION

The traditional design of an anvil for use in an impact wrench includes a round portion that transitions to a square portion. The round portion is received within the impact wrench and acts as a bearing journal. The square portion is received within an impact socket. The transition from the round cross section to the square cross section inherently creates sharp corners or small radii within the transition.

These sharp corners or small radii may create some inefficiencies in the design. Initially there is minimal clearance between the square portion of the anvil and the impact socket when the pieces are new. However, the impact socket may, over a long period of use, become “damaged”, resulting in a looser fit to the square portion of the anvil. This increased clearance between the square portion interface and the impact socket allows the centerline of the square portion of the anvil and the centerline of the impact socket to become non-parallel. When this occurs, the theoretical line contact between the two that exists axially along the interface of the square portion and the impact socket becomes points of contact. These points of contact form at the sharp radii in the transition between the round body and the square drive and lead to zones of increased stress.

Moreover, as the impact socket becomes “damaged”, the corners of the impact socket tend to “dig” into the sharp radii in the transition. This digging between the impact socket and the square portion can damage the anvil, resulting in stress concentration zones. As the stress builds at these points, the anvil may fail at the stress concentration zones. This then can contribute to an early failure of the anvil.

One solution to the problem of sharp radii in an anvil is to increase the overall strength of the anvil. For example, increases in the amount of alloying elements such as carbon or nickel in the steel have been attempted. Unfortunately, this alloying leads to increases in the amount of retained austenite within the anvil. The retained austenite inhibits strength for impact loading and often leads to fatigue failures. Accordingly, there remains a need to provide an improved anvil design that reduces the stress concentration zones and prolongs the life of the anvil.

### SUMMARY OF THE INVENTION

An anvil adapted to be received within an impact wrench is provided. The anvil comprises a round body and a square head formed at an end of the round body. A tapered ramp extends from the round body to the square head. A radius is formed in the transition from the tapered ramp to the square head. The radius has a curvature of about 2 mm. In the transition, all surfaces are blended to eliminate sharp corners and small radii. In another embodiment of the invention, an anvil for an impact tool is provided having a body formed of a steel having less than 0.15% carbon and between about 2.95 and about 3.55% Ni, and between about 1.0 and about 01.45% Cr. The body has an exterior layer having a carbon content greater than 0.15% carbon formed by carburization. The carburized exterior layer has a microstructure having more than 90% tempered martensite formed from a plurality of heat treatment/quenching cycles.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of an exemplary impact wrench having an anvil constructed according to the principles of the present invention;

FIG. 2 is a perspective view of an anvil according to the teachings of the present invention;

FIG. 3 is a cross sectional view of the anvil shown in FIG. 2; and

FIG. 4 is a sectional view of the anvil of FIGS. 2 and 3.

### DETAILED DESCRIPTION OF THE PREFERRED EMBODIMENTS

The following description of the preferred embodiment is merely exemplary in nature and is in no way intended to limit the invention, its application, or uses.

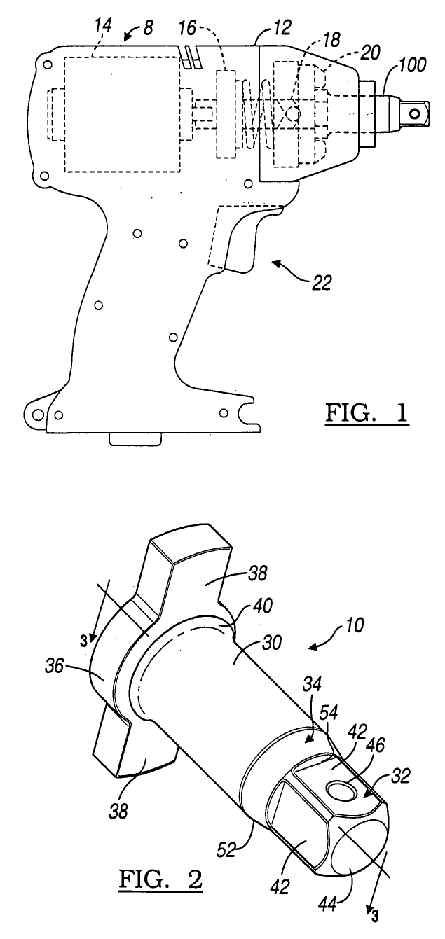

With reference to FIG. 1 of the drawings, an exemplary impact wrench 8 is illustrated to include an improved anvil 100 that is constructed in accordance with the teachings of the present invention. The impact wrench 8 also includes a housing 12 containing an electric motor 14 whose output is coupled to a gear assembly 16. The gear assembly 16 transfers the output to a cam shaft 18 which in turn drives an impactor 20. The improved anvil 100 is mounted within the impactor 20. A trigger and handle assembly 22 mounted to the housing 12 is used to activate the electric motor 14.

The round body 30 is generally cylindrical in shape and includes an enlarged base 36 at one end thereof. The enlarged base 36 includes two locking wings 38 extending therefrom and adapted to be received within the impactor 20. A base radius 40 extends around the circumference of the enlarged base 36 and extends to the round body 30 thereby connecting the two portions.

The square drive head 32 includes side faces 42 and a front face 44. An optional detent pin hole 46 extends from one of the side faces 42 through the drive head 32. The detent pin hole 46 is sized to receive a detent pin, not shown. The square drive head 32 is adapted to be inserted into a tool piece, not shown.

The transition zone 34 includes a tapered ramp 52 extending from the round body 30 to the square drive head 32. A radii 54 is formed at the corners of the square drive head 32 where the faces 42 meet the tapered ramp 52. These radii 54 in the past have formed stress concentration zones and are the sources of potential material failure of the anvil 100.

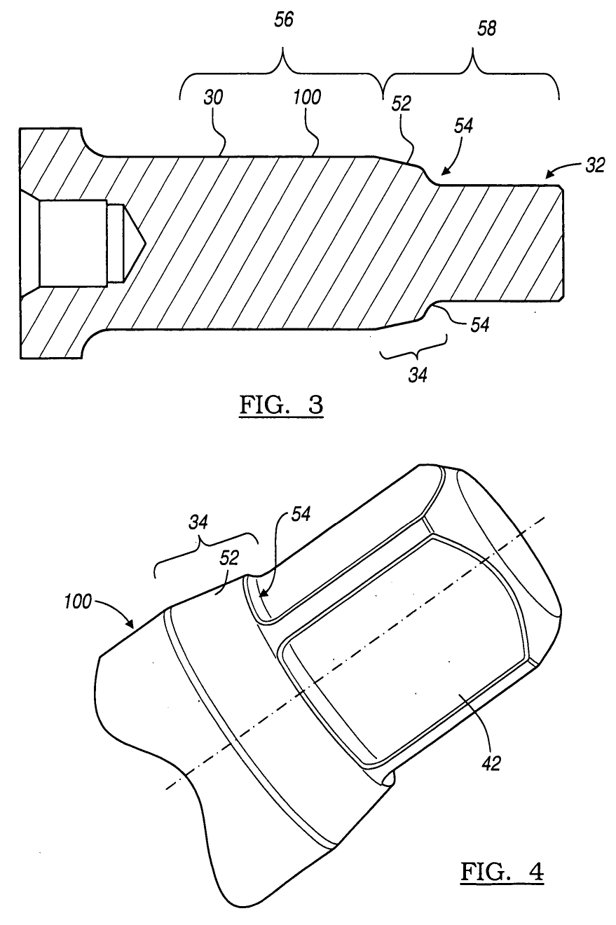

With reference now to FIGS. 3 and 4 and continued reference to FIG. 3, the transition zone 34 includes a tapered ramp 52 extending from the round body 30 to the square drive head 32. It should be understood that the tapered ramp can be eliminated by making the square head and round body of the same general diameter. The anvil 100 design introduces an increase of material in the transition zone 34 between the round body 30 and improved square drive head 32 of the anvil 100, specifically at the tapered ramp 52. This material forms a radius 54 around the circumference at the tapered ramp 52. As shown in FIG. 3, the cross-sectional area of the anvil 100 at the radius 54 is greater than the cross-sectional area of the square drive head 32. The radius 54 eliminates the sharp radii seen on the prior art design and eliminates these stress concentration zones and potential sources of failure in the anvil 100.

The anvil 100 further has a first portion 56 defined by the round body with a circular cross-section and a second portion 58 defined by the square head having a square cross-section with the transition portion defined by the tapered ramp having an exterior radius of about 2 mm. The anvil 100 has a surface with a surface finish of less than 1.8 microns. Specifically, the second portion and the transition portion have surface finishes of less than 1.6 microns, while the first portion or round body 30 has a surface roughness of less than about 0.8 microns. The surface texture of the tapered ramp 34, faces 42, radii 54 and all convex and concave transitions between have a roughness average of less than 1.6 microns Ra, regardless of the lay.

The anvil 100 has a body formed of a steel having less than 0.15% carbon and between 2 and 4% Ni and preferably between 2.95 and 3.55% Ni, and between 0.75 and 1.5% Cr and preferably between 1.0 and 1.45% Cr. Additionally, the anvil 100 preferably has 0.4-0.7% Mn, 0.15-0.3% Si, and 0.08-0.15% Mo. The combination of high Ni and Cr content, along with low carbon content, gives this material the capability to not only maintain high fatigue limits when heat treated, but also maintain very high impact strength. The alloy has a microstructure having more than 90% tempered martensite and, preferably, about 98% tempered martensite formed from a plurality of heat treatment/quenching cycles.

As previously mentioned, the anvil 100 is subjected to carburization and subsequent heat treatment. Specifically, the anvil 100 is subjected to carburization at temperatures from about 1650 to 1700° F. to bring the surface carbon level to between about 0.6 to 1.0% carbon and then quenched. The anvil is then subjected to two reheat and quench cycles to limit the amount of retained austenite. In this regard, the anvil is reheated to between 1450 and 1525° F. in a 0.6 to 1.0% Carbon atmosphere. Quenching is preferably conducted in oil at which has a temperature between 100 and 300° F. The additional heat treatment and quenching cycles are specifically necessary due to the high Ni content of the material. By successively reheating and quenching the material two times, the microstructure of the carburized case is refined and significantly improves the fatigue properties of the materials, giving the impact anvil a 2 to 10 times increase in operating life expectancy.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for producing an anvil for an impact tool comprising:
providing an anvil comprising steel having less than 0.15% C and about 2 to about 4% Ni; and
subjecting the anvil to a plurality of heating and quenching cycles.

2. The method of producing an anvil according to claim 1 wherein the anvil further comprises 0.15-0.3% Si.

3. The method according to claim 1 for producing an anvil wherein subjecting the anvil to a plurality of heat treating and quenching cycles is subjecting the anvil to carburization and quenching and two subsequent reheating and quenching cycles.

4. The method of producing an anvil for heating an impact wrench according to claim 1 wherein subjecting the anvil to a plurality of heat treating cycles is subjecting the anvil to a plurality of heating cycles at temperatures between about 1450 and 1525° F., having a quenching cycle therebetween.

5. The method for providing an anvil for an impact wrench according to claim 1 wherein providing an anvil is providing an anvil having a cylindrical first portion and a square second portion and a transition portion having an exterior radius of 2 mm therebetween.

6. The method of producing an anvil according to claim 5 wherein providing an anvil is providing an anvil having a surface texture of less than 1.6 microns Ra.

7. The method of producing an anvil according to claim 5 wherein the second portion has a surface finish of less than 1.6 microns Ra.

8. A method for producing an anvil for an impact tool comprising:
providing an anvil comprising steel having C, Ni and Cr;
carburizing the anvil until the surface of the anvil has between about 0.6 and about 1.0% C; and
subjecting the anvil to a plurality of heating and quenching cycles.

9. The method of producing an anvil according to claim 8 wherein providing an anvil is providing an anvil comprising more than zero and less than 0.15 % C, between about 2 and about 4% Ni, and between about 0.75 and about 1.5% Cr.

10. The method of producing an anvil according to claim 9 wherein providing an anvil is providing an anvil comprising between about 0.4 and about 0.7% Mn, between about 0.15 and about 0.3% Si, and between about 0.08 and about 0.15%.

11. The method according to claim 8 wherein subjecting the anvil to a plurality of heat treating and quenching cycles is subjecting the anvil to two reheating and quenching cycles.

12. The method of producing an anvil according to claim 8 wherein subjecting the anvil to a plurality of heat treating cycles further comprises subjecting the anvil to at least one heat treating cycle at temperatures between about 1450 and about 152520 F.

13. The method for providing an anvil for an impact wrench according to claim 8 wherein providing an anvil is providing an anvil having a cylindrical first portion and a square second portion and a transition portion having an exterior radius of about 2 mm therebetween.

14. The method of producing an anvil according to claim 12 wherein subjecting the anvil to a plurality of heating and quenching cycles further comprises subjecting the anvil to an oil quench between 100 to 300° F.

15. A method for producing an anvil for an impact tool comprising:
providing an anvil having less than 0.15% C, between about 2 an about 4% Ni and between about 0.75 and about 1.5% Cr;
carburizing the anvil at between about 1650 and 1700° F. until the surface of the anvil has between about 0.6 and about 1.0% C; and
subjecting the anvil to a plurality of heating and quenching cycles.

16. The method according to claim 15 wherein subjecting the anvil to a plurality of heating and quenching cycles is subjecting the anvil to a plurality of heating and quenching cycles until the surface comprises greater than 90% tempered martensite.

17. The method according to claim 16 wherein subjecting the anvil to a plurality of heating and quenching cycles is subjecting the anvil to a plurality of heating and quenching cycles until the surface comprises greater than 98% tempered martensite.

18. The method according to claim 15 wherein subjecting the anvil to a plurality of heating and quenching cycles is subjecting the anvil to a at least one heating cycle at between about 1450 and about 1525° F.

19. The method according to claim 15 wherein subjecting the anvil to a plurality of heating and quenching cycles comprises subjecting the anvil to an oil quench between 100 to 300° F.

20. The method according to claim 15 wherein providing an anvil is providing an anvil having a cylindrical first portion and a square second portion and a transition portion having an exterior radius of 2 mm therebetween.
